(19) United States
(12) Patent Application Publication
(10) Pub. No.: US 2021/0282595 A1
(43) Pub. Date: Sep. 16, 2021

(54) Water Bottle Capable of Freely Adjusting Temperature and Method for Vacuumizing Sealed Space Thereof

(71) Applicant: Seikilife (Shanghai) Housewares Co., Ltd., Shanghai (CN)

(72) Inventor: David Ke, Shanghai (CN)

(73) Assignee: Seikilife (Shanghai) Housewares Co., Ltd.

(21) Appl. No.: 16/815,981

(22) Filed: Mar. 11, 2020

(51) Int. Cl. A47J 41/02; B65D 81/18; A45F 3/18; A47J 41/00

(52) U.S. Cl. CPC A47J 41/022; A47J 41/0044; A45F 3/18; B65D 81/18

(57) ABSTRACT

A water bottle capable of freely adjusting temperature and a method for vacuumizing a sealed space thereof. The vacuumizing method includes: injecting a low-boiling point liquid into a sealed space between an inner container and an outer shell through a liquid injection hole; after the liquid injection is completed, placing a bottle mouth portion of a water bottle upside down, so that the low-boiling point liquid flows to the bottle mouth portion; heating the water bottle to vaporize the low-boiling point liquid, where since the specific gravity of the gas generated after vaporization is greater than the specific gravity of air, the air in the sealed space is lifted upward and discharged from the sealed space through the liquid injection hole; and after heating for a period of time, closing the liquid injection hole to form a vacuum or semi-vacuum state in the sealed space. The traditional vacuumizing method cannot perform vacuumizing after the conventional hand warming bottle or icing bottle is filled with a heat-conducting liquid. According to the present invention, the principle that the vaporization temperature of the low-boiling point liquid is low and the gas generated after vaporization is heavier than air is cleverly utilized for performing vacuumizing, thereby resolving the problem that the traditional vacuumizing process cannot perform vacuumizing after the sealed space is filled with the liquid.

### BACKGROUND

### Technical Field

The present invention relates to daily necessities, and in particular, to a water bottle capable of freely adjusting temperature and a method for vacuumizing a sealed space thereof.

### Related Art

A conventional hand warming bottle or icing bottle is usually composed of an inner container and an outer shell. The inner container and the outer shell are sealed by welding, so that a sealed space is formed between the inner container and the outer shell. The sealed space is vacuum or has very little air, which obstructs the temperature of the inner container from being conducted to the outer shell, thereby playing a role of heat preservation in the sealed space.

A traditional vacuumizing method cannot vacuumize the sealed space of the conventional hand warming bottle or icing bottle. Since the traditional vacuumizing method will form a pressure difference between the sealed space and the outside in the process of forming a vacuum in the sealed space, the aqueous heat-conducting liquid will be pumped out.

### SUMMARY

The present invention mainly aims at the deficiencies of the prior art, and provides a water bottle capable of freely adjusting temperature and a method for vacuumizing a sealed space thereof, thereby resolving the problem that the traditional vacuumizing process cannot perform vacuumizing after a liquid is injected into the sealed space.

The technical solution adopted by the present invention is as follows: A water bottle capable of freely adjusting temperature is provided, including an inner container and an outer shell disposed outside the inner container, where the top of the inner container and the top of the outer shell are hermetically welded together to form a bottle mouth portion, a sealed space is formed between the inner container and the whole body and the bottom of the outer shell, a low-boiling point liquid is injected into the sealed space, and the boiling point temperature of the low-boiling point liquid is not higher than 60° C.

For further improvement of the water bottle capable of freely adjusting temperature, the boiling point temperature of the low-boiling point liquid is between 30° C. and 60° C.

For further improvement of the water bottle capable of freely adjusting temperature, the liquid level of the low-boiling point liquid injected into the sealed space is lower than the bottom surface of the inner container when the water bottle is placed upright.

For further improvement of the water bottle capable of freely adjusting temperature, the low-boiling point liquid is injected into the sealed space by forming a liquid injection hole at the bottom of the outer shell.

For further improvement of the water bottle capable of freely adjusting temperature, a bottom cover is disposed on the bottom of the outer shell in a covering manner.

A method for vacuumizing a sealed space of a water bottle capable of freely adjusting temperature is provided, where the bottom of an outer shell of the water bottle is provided with a liquid injection hole, and the vacuumizing method includes:

injecting a low-boiling point liquid into the sealed space between the inner container and the outer shell through the liquid injection hole, and controlling the liquid level of the low-boiling point liquid injected into the sealed space to be lower than the bottom surface of the inner container when the water bottle is placed upright;

after the liquid injection is completed, placing a bottle mouth portion of the water bottle upside down, so that the low-boiling point liquid flows to the bottle mouth portion;

heating the water bottle to vaporize the low-boiling point liquid, where since the specific gravity of the gas generated after vaporization is greater than the specific gravity of air, the air in the sealed space is lifted up and is discharged from the sealed space through the liquid injection hole; and after heating for a period of time, closing the liquid injection hole to form a vacuum or semi-vacuum state in the sealed space.

For further improvement of the method for vacuumizing a sealed space, when the liquid is injected into the sealed space through the liquid injection hole, the liquid level of the injected low-boiling point liquid is controlled to be lower than the bottom surface of the inner container when the water bottle is placed upright.

For further improvement of the method for vacuumizing a sealed space, the boiling point temperature of the low-boiling point liquid is between 30° C. and 60° C.

For further improvement of the method for vacuumizing a sealed space, the liquid injection hole is closed by tin soldering.

Due to the adoption of the above technical solution, the present invention has the following beneficial effects:

1. The traditional vacuumizing method cannot vacuumize the conventional hand warming bottle or icing bottle. The present invention performs vacuumizing by cleverly utilizing the principle that the low-boiling point liquid has a low vaporization temperature and the gas generated after vaporization is heavier than air.

2. Due to the phase change of the low-boiling point liquid, the intensity of pressure of the sealed space between the inner container and the outer shell is changed to reduce or increase the boiling point temperature of the low-boiling point liquid, thereby achieving rapid temperature conduction when cold or hot compress is required.

3. The intensity of pressure of the sealed space is relatively low after vacuumizing. In this case, the vaporization temperature of the low-boiling point liquid will decrease, so that the vaporization process will be faster than the normal pressure state when the low-boiling point liquid makes contact with the high-temperature inner container, and more heat will be absorbed more rapidly. Meanwhile, due to rapid vaporization, the sealed space is filled with a large amount of gas, so that the intensity of pressure in the sealed space rises rapidly. Therefore, the liquefaction temperature of the heat-conducting gas generated after the low-boiling point liquid is vaporized rises, and the heat-conducting gas is more easily liquefied. Since liquefaction releases a large amount of heat, the temperature of the outer shell rises rapidly, thereby achieving the effect of rapidly conducting the heat of the inner container to the outer shell.

4. The air pressure in the sealed space can be changed and is lower than the normal atmospheric pressure when standing still. After the inner container is filled with the liquid with a temperature exceeding the boiling point temperature of the low-boiling point liquid, the air pressure will be higher than the normal atmospheric pressure if the bottle is shaken.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show merely some embodiments of the present invention, and a person of ordinary skill in the technology may still derive other drawings from these accompanying drawings without creative efforts.

FIG. 1 is a schematic structural diagram of a water bottle capable of freely adjusting temperature according to an embodiment of the present invention.

### DETAILED DESCRIPTION

The following describes the embodiments of the present invention through specific examples. A person skilled in the art can easily understand other advantages and effects of the present invention from the content disclosed in this specification. The present invention may also be implemented or applied through different specific embodiments. Various details in this specification may also be modified or changed based on different viewpoints and applications without departing from the spirit of the present invention.

The following further describes the present invention in detail with reference to the accompanying drawings and specific embodiments.

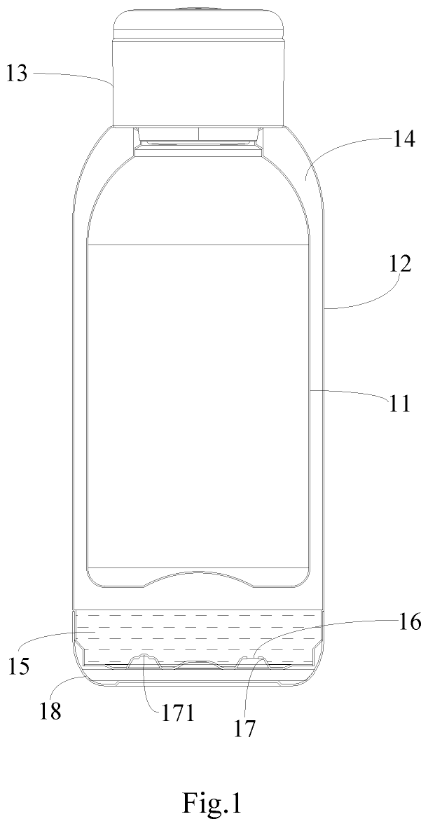

Referring to FIG. 1, an embodiment of the present invention provides a water bottle capable of freely adjusting temperature, which mainly includes two parts: an inner container 11 and an outer shell 12. The inner container 11 and the outer shell 12 are both shaped like a cylindrical bottle body, the top is open, the bottom is closed, and the whole body is cylindrical. The circumference of the inner container 11 is less than that of the outer shell 12. The inner container 11 is disposed inside the outer shell 12, and the open tops of the inner container 11 and the outer shell 12 are hermetically welded together to form a bottle mouth portion of the water bottle. Preferably, the open tops of the inner container 11 and the outer shell 12 are welded integrally and then extend upward to form a ring-shaped bottle mouth portion. A bottle lid 13 covers the outer part of the bottle mouth portion and is configured to keep the liquid contained in the inner container 11 warm or cold. The connection between the bottle mouth portion and the bottle lid 13 is the conventional design of a vacuum bottle, for example, thread screwing.

The height of the inner container 11 is less than the height of the outer shell 12. After the two are welded at the bottle mouth portion, a sealed space 14 is formed between the inner container 11 and the whole body and bottom of the outer shell 12. The sealed space 14 separates the inner container 11 from the outer shell 12. The sealed space 14 is in a vacuum or semi-vacuum state and obstructs the temperature of the inner container 11 from being conducted to the outer shell 12, thereby playing a role of heat preservation. A low-boiling point liquid 15 is injected into the sealed space 14. The height of the low-boiling point liquid 15 (the amount of the low-boiling point liquid) should meet the condition that the liquid level cannot contact the inner container 11 when the water bottle is placed upright. Therefore, when the water bottle is placed upright, the sealed space 14 is enabled to separate the low-boiling point liquid 15 from the inner container 11 to play a role of heat preservation, so that the liquid contained in the inner container 11 is subjected to heat preservation for a longer time.

The boiling point temperature of the low-boiling point liquid 15 (at normal temperature and normal pressure) should be lower than 60° C. Preferably, the boiling point temperature of the low-boiling point liquid 15 is between 30° C. and 60° C. Such a low-boiling point liquid 15 may be selected from, for example, perfluorohexanone, and the low-boiling point liquid such as perfluorohexanone has a higher specific gravity than that of air after heating and vaporization. The material of the inner container 11 and the outer shell 12 may be selected from the materials such as stainless steel, aluminum and copper. The low-boiling point liquid 15 is injected into the sealed space 14 by forming a liquid injection hole 16 at the bottom of the outer shell 12. After the low-boiling point liquid 15 is injected, the liquid injection hole 16 is not immediately sealed, but the water bottle is inverted (the bottle mouth portion is placed upside down), so that the low-boiling point liquid 15 is located at the bottle mouth portion. The low-boiling point liquid 15 is gradually vaporized or partially vaporized by heating the water bottle. Since the specific gravity of the gas generated after the low-boiling point liquid 15 is vaporized is greater than the specific gravity of air, the air in the sealed space 14 is lifted upward. After most or all of the air is discharged from the sealed space 14, the liquid injection hole 16 is closed, so that the interior of the sealed space 14 is in a vacuum or semi-vacuum state. Therefore, the problem that the traditional vacuumizing process cannot perform vacuumizing after the liquid is injected into the sealed space 14 is resolved effectively. Since the traditional vacuumizing process forms a pressure difference between the sealed space 14 and the external atmospheric pressure in the process of forming a vacuum in the sealed space 14, the aqueous low-boiling point liquid 15 will be pumped out. Due to the low gas pressure in the vacuum environment, the boiling point temperature of the low-boiling point liquid 15 will decrease. Therefore, the low-boiling point liquid 15 will be more easily pumped out together with the air. Therefore, a sufficient amount of low-boiling point liquid cannot be left in the sealed space after the vacuumizing process, and then the heat preservation effect of the water bottle is damaged.

The boiling point temperature of the low-boiling point liquid 15 has the optimal effect in the preferable temperature range of 30° C. to 60° C. The upper limit of the boiling point is set to 60° C. for the reason that hot drinks exceeding 60° C. are not suitable for direct drinking and easily cause esophageal damage. The lower limit of the boiling point is set to 30° C. for the reason that the effect is actually not so good below 30° C. If water continues to release heat when the water temperature is lower than the human body temperature, the water temperature will become very low. Meanwhile, the heat preservation effect becomes worse, and the heat preservation effect will be greatly affected by the external temperature.

Further referring to FIG. 1, the bottom surface of the outer shell 12 is provided with a pit 17 used for forming the liquid injection hole 16 and recessed to the inside of the outer shell 12. There may be one or more pits 17, the pit 17 is in the shape of a conical frustum, and the inner diameter of the pit gradually decreases from the bottom to the inside of the outer shell 12. When the liquid injection hole is formed, the pit 17 has the functions of guiding and positioning, which is conducive to fast drilling and positioning. Preferably, a positioning tip 171 which continues to be recessed to the inside of the outer shell 12 may be further formed at the middle location on the surface of the conical frustum of the pit 17. The tip 171 has a pointed shape which is matched with the tip shape of a drilling apparatus, for example, a drilling rod of a drilling machine, and the drilling location can be better positioned without deviation. Moreover, by disposing the above pit 17, the drilling location can be restricted within the pit range, without damaging other parts of the bottom of the outer shell outside the pit, thereby protecting the water bottle.

In addition, a bottom cover 18 covers the outer side of the bottom of the outer shell 12 and is configured to cover the bottom of the outer shell which is operated during the production of the water bottle, thereby further playing the roles of aesthetics and leakage prevention.

The traditional vacuumizing method cannot perform vacuumizing after the conventional hand warming bottle or icing bottle is filled with the heat-conducting liquid. The present invention performs vacuumizing by cleverly using the principle that the vaporization temperature of the low-boiling point liquid 15 is not high and the gas generated after vaporization is heavier than air. The specific operation is as follows:

At first, a liquid injection hole 16 is formed at the bottom of the outer shell 12 of the water bottle, and the liquid injection hole 16 may be quickly and accurately formed through the pit 17 previously disposed at the bottom of the outer shell 12.

Next, a liquid injection machine is inserted into the liquid injection hole 16, and the low-boiling point liquid 15 is injected into the sealed space 14 between the inner container 11 and the outer shell 12 through the liquid injection hole 16. The liquid level of the low-boiling point liquid 15 injected into the sealed space 14 is controlled to be lower than the bottom surface of the inner container 11 when the water bottle is placed upright, that is, the low-boiling point liquid 15 is controlled to make no contact with the inner container 11, for the reason that the effect of heat preservation will be lost since the low-boiling point liquid 15 will be vaporized if the inner container 11 is filled with hot water after the contact, and the inner container 11 will continue to release heat.

After the liquid injection is completed, the bottle mouth portion of the water bottle is placed upside down, so that the low-boiling point liquid 15 flows to the bottle mouth portion located below.

Then, the entire water bottle filled with the low-boiling point liquid 15 is heated. Preferably, the bottle mouth portion at the lower part of the inverted water bottle can be heated since the low-boiling point liquid is closer to the bottle mouth portion, so that the low-boiling point liquid 15 is vaporized. After being vaporized, the low-boiling point liquid becomes gaseous low-boiling point liquid. The low-boiling point liquid is preferably selected from low-boiling point liquid such as perfluorohexanone with a boiling point temperature between 30° C. and 60° C. After vaporization, the specific gravity of the gaseous low-boiling point liquid is greater than that of air, and the air in the sealed space 14 is lifted upward and discharged from the sealed space 14 through the liquid injection hole.

After heating for a period of time, the liquid injection hole 16 is sealed by tin soldering, so that a vacuum or semi-vacuum state is formed in the sealed space.

The heating time is related to the heating temperature, the shape design of the inner container, the choice of a bottle body material and the like. It is ensured that the sealed space can reach the vacuum or semi-vacuum state while specific data can be obtained through repeated tests of the designed bottle body.

Therefore, on one hand, the present invention provides a new water bottle structure capable of freely adjusting temperature. The structure is simple, but the functions are complete, and the water bottle has the functions of heat preservation, cold preservation, hand warming, and icing. On the other hand, the present invention further provides a method for vacuumizing a sealed space in such a water bottle capable of freely adjusting temperature after liquid injection.

In addition, the low-boiling point liquid has a low vaporization temperature and is easy to vaporize, so that the intensity of pressure of the sealed space between the inner container and the outer shell of the water bottle changes faster due to the gas-liquid phase change of the low-boiling point liquid, and the boiling point temperature of the low-boiling point liquid is reduced or increased, thereby achieving rapid temperature conduction between the inner container and the outer shell of the water bottle. The intensity of pressure of the sealed space is relatively low after vacuumizing. In this case, the vaporization temperature of the low-boiling point liquid will decrease, so that the vaporization process will be faster than the normal pressure state when the low-boiling point liquid makes contact with the high-temperature inner container, and more heat will be absorbed more rapidly. Meanwhile, due to rapid vaporization, the sealed space is filled with a large amount of gas, so that the intensity of pressure in the sealed space rises rapidly. Therefore, the liquefaction temperature of the heat-conducting gas generated after the low-boiling point liquid is vaporized rises, and the heat-conducting gas is more easily liquefied. Since liquefaction releases a large amount of heat, the temperature of the outer shell rises rapidly, thereby achieving the effect of rapidly conducting the heat of the inner container to the outer shell.

Specifically, the low-boiling point liquid 15 is in a low pressure state (the vacuum or semi-vacuum state of the sealed space), and therefore has a boiling point temperature lower than that in a normal temperature and pressure state, so that the low-boiling point liquid is easier to vaporize than the normal pressure state, and the vaporization process is faster. The low-boiling point liquid 15 absorbs a large amount of heat during the vaporization process, so that the vaporization process of the low-boiling point liquid 15 is faster. The change of the heat absorbed during vaporization is larger, so that the heat conduction of the gas generated after the low-boiling point liquid 15 is vaporized is faster, thereby accelerating the heat conduction between the inner container and the outer shell.

When the inner container of the water bottle is filled with a hot liquid (the temperature is higher than 60° C. or higher than the boiling point temperature of low-boiling point liquid 15 to 100° C.), and the water bottle is placed upright, the sealed space between the inner container and the outer shell of the water bottle is in the vacuum or semi-vacuum state, so that the effect of heat preservation can be realized for a long time.

When the temperature in the bottle is intended to quickly drop to a temperature suitable for drinking or the water bottle is intended to warm the hands, the water bottle can be shaken to enable the low-boiling point liquid 15 in the water bottle to make contact with the inner container 11, and the inner container 11 conducts heat to the low-boiling point liquid 15 to rapidly vaporize the low-boiling point liquid 15 in the water bottle. The heat-conducting gas generated after vaporization fills the sealed space 14, so that the inner container 11 and the outer shell 12 conduct the heat through the gas generated by the vaporization of the low-boiling point liquid 15, thereby conducting out the heat of the hot liquid in the bottle. Hence, the temperature of the hot liquid is quickly reduced to a temperature suitable for drinking, and meanwhile, the temperature of the outer shell 12 rises to warm the hands holding the water bottle.

The gaseous low-boiling point liquid 15 will sharply increase the intensity of pressure in the sealed space 14, so that the liquefaction temperature of the gas generated after vaporization of the low-boiling point liquid 15 will increase. When the gas generated after vaporization of the low-boiling point liquid 15 makes contact with the outer shell 12, the gaseous low-boiling point liquid 15 will perform heat exchange with the outer shell 12, so that the temperature of the place at which the gaseous low-boiling point liquid 15 makes contact with the outer shell 12 is the same as that of the outer shell 12, and meanwhile, both of the temperatures are lower than the temperature of the liquid contained in the inner container 11. The temperature of the outer shell 12 is generally lower than the liquefaction temperature of the heat-conducting liquid 15. Therefore, when the water bottle is stopped from being shaken and is placed upright, the gaseous low-boiling point liquid 15 will be rapidly liquefied into the low-boiling point liquid 15. The liquefaction process is a heat release process and releases a lot of heat, which is absorbed by the outer shell 12 with a lower temperature, thereby making the entire heat conduction process very fast. The gaseous low-boiling point liquid 15 is liquefied into a liquid and deposited at the bottom of the sealed space 14, so that the sealed space 14 is in the vacuum or semi-vacuum state again, thereby achieving a quite good heat preservation effect.

After the inner container 11 is filled with ice water, cold water or an ice-water mixture, the contained content can be kept at a low temperature for a long time. When icing is required, the bottle body is shaken to cause the low-boiling point liquid 15 to make contact with the inner container 11 and the outer shell 12 back and forth, so that the low temperature of the inner container 11 is conducted to the outer shell 12. Hence, the temperature of the outer shell 12 is reduced and comfortable icing can be performed by placing the water bottle in a location at which icing is required.

It should be noted that, the structures, proportions, sizes, and the like depicted in the accompanying drawings of this specification merely serve to illustrate the disclosure of this specification to allow for reading and understanding by those skilled in the art, are not intended to limit the implementation of the present invention, and therefore do not constitute any substantial technical meaning. Any modification of a structure, alteration of a proportional relationship, or adjustment of a size shall still fall within the scope of the technical content disclosed in the present invention without affecting the effects and objectives of the present invention. Meanwhile, terms such as “above”, “below”, “left”, “right”, “middle”, “a/an”, and the like in this specification are only used for the clarity of description, and are not intended to limit the implementation scope of the present invention. Without substantially changing the technical content, an alteration or adjustment of the relative relationship of such terms shall be construed as falling within the implementation scope of the present invention.

The foregoing descriptions are merely preferred embodiments of the present invention, and are not intended to limit the present invention in any form. Although the present invention has been disclosed above through the preferred embodiments, the embodiments are not intended to limit the present invention. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of the present invention without departing from the content of the technical solutions of this application shall fall within the scope of the technical solutions of the present invention.

What is claimed is:

1. A water bottle capable of freely adjusting temperature, comprising: an inner container and an outer shell disposed outside the inner container, wherein the top of the inner container and the top of the outer shell are hermetically welded to form a bottle mouth portion, a sealed space is formed between the inner container and the whole body and the bottom of the outer shell, a low-boiling point liquid is injected into the sealed space, and the boiling point temperature of the low-boiling point liquid is not higher than 60° C.

2. The water bottle capable of freely adjusting temperature according to claim 1, wherein the boiling point temperature of the low-boiling point liquid is between 30° C. and 60° C.

3. The water bottle capable of freely adjusting temperature according to claim 1, wherein the liquid level of the low-boiling point liquid injected into the sealed space is lower than the bottom surface of the inner container when the water bottle is placed upright.

4. The water bottle capable of freely adjusting temperature according to claim 1, wherein the low-boiling point liquid is injected into the sealed space by forming a liquid injection hole at the bottom of the outer shell.

5. The water bottle capable of freely adjusting temperature according to claim 1, wherein a bottom cover is disposed on the bottom of the outer shell in a covering manner.

6. A method for vacuumizing a sealed space of the water bottle capable of freely adjusting temperature according to any one of claims 1 to 5, wherein the bottom of an outer shell of the water bottle is provided with a liquid injection hole, and the vacuumizing method comprises:
injecting a low-boiling point liquid into the sealed space between the inner container and the outer shell through the liquid injection hole, and controlling the liquid level of the low-boiling point liquid injected into the sealed space to be lower than the bottom surface of the inner container when the water bottle is placed upright;
after the liquid injection is completed, placing a bottle mouth portion of the water bottle upside down, so that the low-boiling point liquid flows to the bottle mouth portion;
heating the water bottle to vaporize the low-boiling point liquid, wherein since the specific gravity of the gas generated after vaporization is greater than the specific gravity of air, the air in the sealed space is lifted up and is discharged from the sealed space through the liquid injection hole; and
after heating for a period of time, closing the liquid injection hole to form a vacuum or semi-vacuum state in the sealed space.

7. The method for vacuumizing a sealed space according to claim 6, wherein when the liquid is injected into the sealed space through the liquid injection hole, the liquid level of the injected low-boiling point liquid is controlled to be lower than the bottom surface of the inner container when the water bottle is placed upright.

8. The method for vacuumizing a sealed space according to claim 6, wherein the boiling point temperature of the low-boiling point liquid is between 30° C. and 60° C.

9. The method for vacuumizing a sealed space according to claim 6, wherein the liquid injection hole is closed by tin soldering.
